(19) United States
(12) Patent Application Publication
(10) Pub. No.: US 2013/0176294 A1
(43) Pub. Date: Jul. 11, 2013

(54) PLASMA DISPLAY PANEL DRIVE METHOD AND PLASMA DISPLAY DEVICE

(71) Applicants: Takahiko Origuchi, Osaka (JP); Yuya Shiozaki, Osaka (JP); Ayuhiko Saito, Osaka (JP); Hidehiko Shoji, Osaka (JP)

(72) Inventors: Takahiko Origuchi, Osaka (JP); Yuya Shiozaki, Osaka (JP); Ayuhiko Saito, Osaka (JP); Hidehiko Shoji, Osaka (JP)

(73) Assignee: PANASONIC CORPORATION, Osaka (JP)

(21) Appl. No.: 13/823,679

(22) PCT Filed: Oct. 12, 2011
(86) PCT No.: PCT/JP2011/005699

§ 371 Date: Mar. 28, 2013

(30) Foreign Application Priority Data
Oct. 12, 2010 (JP) 2010-229423

(51) Int. Cl. G09G 1/00

(52) U.S. Cl. CPC G09G 1/005
USPC 345/211

(57) ABSTRACT

In the plasma display apparatus, accidental discharge is prevented from occurring in a second discharge cell. For this purpose, in driving a plasma display panel having first data electrodes and second data electrodes that are arranged in parallel with the first data electrodes in a region outside the region where the plurality of first data electrodes are arranged, first voltage is set to be higher than second voltage in at least one subfield. Here, it is assumed that the first voltage is the voltage derived by subtracting the voltage applied to the first data electrodes from the voltage applied to the second data electrodes when down-ramp waveform voltage is applied to scan electrodes in the initializing period, and the second voltage is the voltage derived by subtracting the low-voltage-side voltage of the address pulse applied to the first electrodes from the voltage applied to the second data electrodes in the address period.

### TECHNICAL FIELD

The present invention relates to a driving method of an alternating-current surface discharge type plasma display panel, and a plasma display apparatus.

### BACKGROUND ART

An alternating-current surface discharge type panel typical as a plasma display panel (hereinafter referred to as “panel”) has many discharge cells between a front substrate and a rear substrate that are faced to each other. The front substrate has the following elements:
a plurality of display electrode pairs disposed in parallel on a front glass substrate; and
a dielectric layer and protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure ratio of 5%, for example, is filled into a discharge space in the sealed product. Discharge cells are disposed in the intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing waveform is applied to each scan electrode, and initializing discharge is caused in each discharge cell.

In the address period, a scan pulse is sequentially applied to scan electrodes, and an address pulse is selectively applied to data electrodes based on an image signal to be displayed. Thus, address discharge is caused in the discharge cell to emit light.

In a sustain period, as many sustain pulses as a number based on the luminance weight determined for each subfield are alternately applied to the display electrode pairs formed of the scan electrodes and the sustain electrodes. Thus, light is emitted at a luminance corresponding to the luminance weight in a discharge cell having undergone address discharge. Thus, light is emitted at a luminance corresponding to the gradation value of the image signal in each discharge cell of the panel, and an image is displayed on the image display region of the panel.

Regarding a panel having such a structure, when the panel is fired during manufacturing thereof, the barrier ribs contract, but slightly. Therefore, in a periphery of the panel, tension toward the inside of the panel occurs during the firing of the panel, and deformation is apt to occur in the barrier ribs of the discharge cells in the periphery of the panel. In the regions at both ends of the array direction of the data electrodes, variation is apt to occur in the discharge characteristic when the deformation of the discharge cells occurs, and, as a result, luminance irregularity or accidental discharge is apt to occur.

Therefore, generally, the discharge cells formed in the periphery of the panel, especially in the regions at both ends of the array direction of the data electrodes, are not used for image display.

Hereinafter, the region of the panel periphery that is not used for image display is referred to as “no-display region”, and the region of the panel that is used for image display is referred to as “display region”.

The discharge cell used for image display is referred to as “first discharge cell” or simply “discharge cell”, and the discharge cell existing in “no-display region” is referred to as “second discharge cell”.

The data electrode forming the first discharge cell is referred to as “first data electrode” or simply “data electrode”, and the data electrode forming the second discharge cell is referred to as “second data electrode”.

Therefore, “no-display region” is formed outside “display region”, namely in the peripheral region of panel 10, and the number of “second discharge cells” is smaller than the number of “first discharge cells”.

In order to improve the image display quality of the plasma display apparatus, it is preferable that light is not emitted in the second discharge cell existing in “no-display region”.

Therefore, a plasma display apparatus is disposed where, in order to prevent light emission in the second discharge cell, several second data electrodes are electrically interconnected and are grounded via a capacitor, and a resistor is connected to the capacitor in parallel (for example, Patent Literature 1).

Recently, as the definition of the panel is enhanced and the screen thereof is enlarged, the discharge start voltage is apt to increase. In such a panel where the definition is enhanced and the screen is enlarged, discharge is controlled by applying a voltage higher than the conventional driving voltage to each electrode.

In order to enhance the definition of the panel and sharpen the contrast of the display image, the driving voltage waveform is speeded up and complicated.

While, as a problem in manufacturing the panel, the thickness of the dielectric layer in the panel periphery is apt to decrease. In the panel periphery, therefore, voltage drop in the dielectric layer is apt to decrease and a large voltage is apt to be applied to the second discharge cell.

Usually, no phosphor layer is formed in the second discharge cell. The purpose of this is to prevent unnecessary light emission from occurring when accidental discharge occurs in the second discharge cells. However, the phosphor layer has a function of disturbing discharge. Therefore, in the second discharge cell having no phosphor layer, the discharge start voltage is lower than that in the first discharge cell having a phosphor layer.

As discussed above, the barrier ribs of the discharge cells in the panel periphery are apt to become deformed. When a clearance occurs between the barrier ribs in the panel periphery, the panel periphery is apt to be affected by discharge in an adjacent cell.

Thus, discharge is more apt to occur in the second discharge cell than in the first discharge cell. In the technology disclosed in Patent Literature 1, it is difficult to suppress discharge in the second discharge cells.

When accidental discharge occurs in the second discharge cell and light is emitted in the second discharge cell, the image display quality decreases.

### Citation List

Patent Literature

PTL 1 Unexamined Japanese Patent Publication No. 2005-91555

### SUMMARY OF THE INVENTION

A driving method of a panel of the present invention includes the following steps:
forming one field using a plurality of subfields having an initializing period, an address period, and a sustain period; and
driving the panel that has scan electrodes and sustain electrodes arranged in parallel with each other, first data electrodes arranged in the direction three-dimensionally crossing the scan electrodes, and second data electrodes arranged in parallel with the first data electrodes in a region outside the region where a plurality of first data electrodes are arranged.
   In this driving method, first voltage is set to be higher than second voltage in at least one subfield. Here, these voltages are assumed as follows:
the first voltage is the voltage derived by subtracting the voltage applied to the first data electrodes from the voltage applied to the second data electrodes when down-ramp waveform voltage is applied to scan electrodes in the initializing period; and
the second voltage is the voltage derived by subtracting the low-voltage-side voltage of the address pulse applied to the first electrodes from the voltage applied to the second data electrodes in the address period.

Thus, in the plasma display apparatus, accidental discharge can be prevented from occurring in the second discharge cells, and the reduction in image display quality by light emission of the second discharge cells can be prevented.

In the driving method of the panel of the present invention, when down-ramp waveform voltage is applied to the scan electrodes in the initializing period of at least one subfield, voltage of positive polarity may be applied to the second data electrodes and voltage equal to the low-voltage-side voltage of the address pulse may be applied to the first data electrodes. When down-ramp waveform voltage is applied to the scan electrodes in the initializing periods of the other subfields, voltage of positive polarity may be applied to the second data electrodes and voltage of positive polarity may be applied to the first data electrodes.

A plasma display apparatus of the present invention includes the following elements:
a panel having scan electrodes and sustain electrodes arranged in parallel with each other, first data electrodes arranged in the direction three-dimensionally crossing the scan electrodes, and second data electrodes arranged in parallel with the first data electrodes in a region outside the region where a plurality of first data electrodes are arranged; and
a driving circuit for forming one field using a plurality of subfields having an initializing period, an address period, and a sustain period, and generating a driving voltage waveform and applying it to each electrode of the panel.

In the plasma display apparatus, the driving circuit sets first voltage to be higher than second voltage in at least one subfield. Here, these voltages are assumed as follows:
the first voltage is the voltage derived by subtracting the voltage applied to the first data electrodes from the voltage applied to the second data electrodes when down-ramp waveform voltage is applied to scan electrodes in the initializing period; and
the second voltage is the voltage derived by subtracting the low-voltage-side voltage of the address pulse applied to the first electrodes from the voltage applied to the second data electrodes in the address period.

Thanks to this configuration, in the plasma display apparatus, accidental discharge can be prevented from occurring in the second discharge cells, and the reduction in image display quality by light emission of the second discharge cells can be prevented.

### BRIEF DESCRIPTION OF DRAWINGS

FIG. 1 is an exploded perspective view showing a structure of a panel used for a plasma display apparatus in accordance with a first exemplary embodiment of the present invention.

FIG. 2 is an electrode array diagram of the panel used for the plasma display apparatus in accordance with the first exemplary embodiment of the present invention.

FIG. 3 is a diagram for schematically showing a driving voltage waveform applied to each electrode of the panel used for the plasma display apparatus in accordance with the first exemplary embodiment of the present invention.

FIG. 4A is a diagram showing variation in wall voltage of a first discharge cell of the plasma display apparatus in accordance with the first exemplary embodiment of the present invention.

FIG. 4B is a diagram showing variation in wall voltage of a second discharge cell of the plasma display apparatus in accordance with the first exemplary embodiment of the present invention.

FIG. 5 is a diagram for schematically showing one example of circuit blocks constituting the plasma display apparatus in accordance with the first exemplary embodiment of the present invention.

FIG. 6 is a circuit diagram for schematically showing the configuration of a data electrode driver circuit for driving a first data electrode of the plasma display apparatus in accordance with the first exemplary embodiment of the present invention.

FIG. 7 is a circuit diagram for schematically showing the configuration of a second data electrode driver circuit for driving a second data electrode of the plasma display apparatus in accordance with the first exemplary embodiment of the present invention.

FIG. 8 is a diagram for schematically showing a driving voltage waveform applied to each electrode of a panel used for a plasma display apparatus in accordance with a second exemplary embodiment of the present invention.

FIG. 9 is a diagram showing one example of a generation pattern of a forced initializing operation and selective initializing operation in accordance with the second exemplary embodiment of the present invention.

FIG. 10 is a diagram for schematically showing another example of the driving voltage waveform applied to each electrode of the panel used for the plasma display apparatus in accordance with the second exemplary embodiment of the present invention.

### DESCRIPTION OF EMBODIMENTS

A plasma display apparatus in accordance with exemplary embodiments of the present invention will be described hereinafter with reference to the accompanying drawings.

### First Exemplary Embodiment

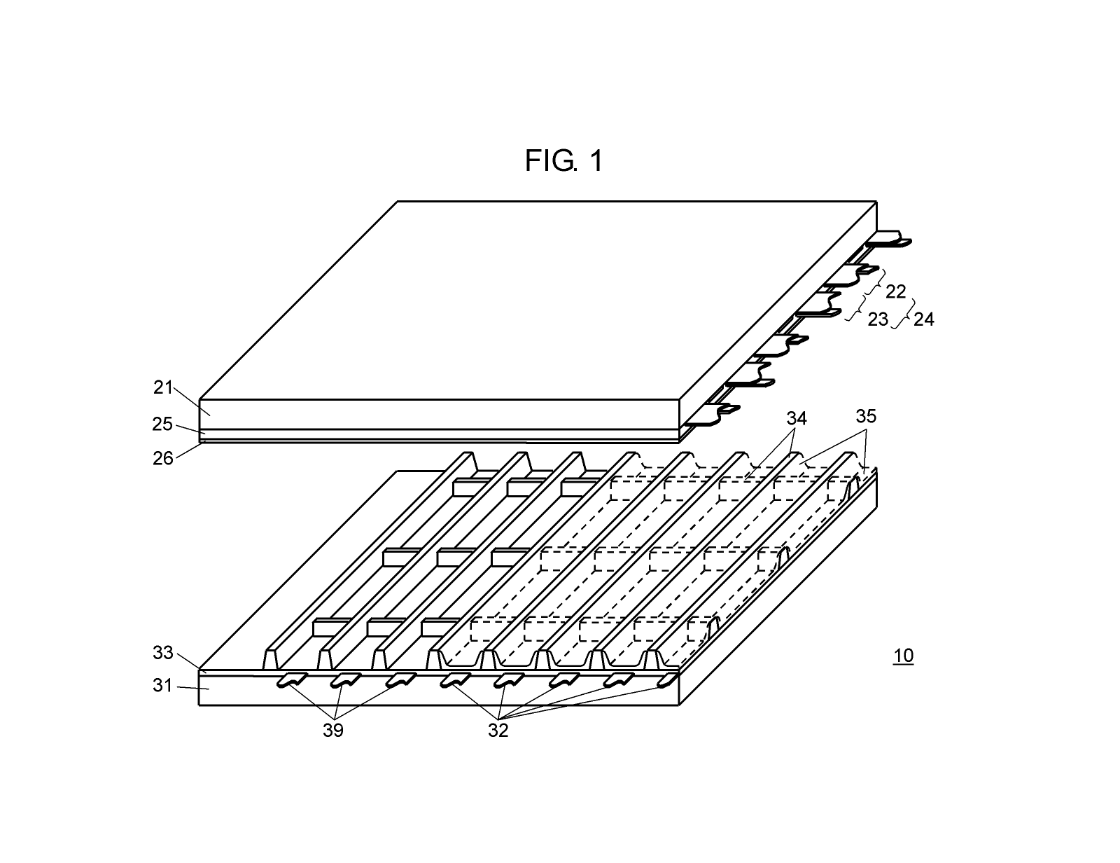

FIG. 1 is an exploded perspective view showing the structure of panel 10 used for a plasma display apparatus in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25.

In order to reduce the discharge start voltage in discharge cells to facilitate occurrence of discharge, protective layer 26 is made of a material mainly made of magnesium oxide (MgO) that has high electron emission performance and high durability when mixed gas of neon (Ne) and xenon (Xe) is filled.

On rear substrate 31, a plurality of first data electrodes 32 is formed in a display region, and a plurality of second data electrodes 39 is formed in parallel with first data electrodes 32 in a no-display region, which is a region outside the region having the plurality of first data electrodes 32 (end sides of panel 10). Dielectric layer 33 is formed so as to cover first data electrodes 32 and second data electrodes 39, and mesh barrier ribs 34 are formed on dielectric layer 33. Phosphor layers 35R for emitting light of red color (R), phosphor layers 35G for emitting light of green color (0), and phosphor layers 35B for emitting light of blue color (B) are formed on the side surfaces of barrier ribs 34 and on dielectric layer 33. Hereinafter, phosphor layers 35R, phosphor layers 35G, and phosphor layers 35B are collectively denoted as phosphor layers 35. Front substrate 21 and rear substrate 31 are faced to each other so that display electrode pairs 24 three-dimensionally cross first data electrodes 32 with a micro discharge space sandwiched between them, and the outer peripheries of them are sealed by a sealing material such as glass frit. The discharge space is filled with mixed gas of neon and xenon as discharge gas, for example.

The discharge space is partitioned into a plurality of sections by barrier ribs 34. First discharge cells are formed in the intersecting parts of display electrode pairs 24 and first data electrodes 32.

Then, discharge is caused in these first discharge cells and light is emitted (lighting of first discharge cells) in phosphor layers 35 in the first discharge cells, thereby displaying a color image on panel 10.

In panel 10, one pixel is formed of three consecutive discharge cells arranged in the extending direction of display electrode pairs 24. The three discharge cells are a discharge cell (red discharge cell) that has phosphor layer 35R and emits light of red color (R), a discharge cell (green discharge cell) that has phosphor layer 35G and emits light of green color (0), and a discharge cell (blue discharge cell) that has phosphor layer 35B and emits light of blue color (B).

FIG. 1 shows an example where three second data electrodes 39 are formed on panel 10, but the number of second data electrodes 39 is not limited to three in the present invention.

Panel 10 of FIG. 1 shows an example where no phosphor layer 35 is formed on the side surfaces of barrier ribs 34 and on dielectric layer 33 for covering second data electrodes 39. However, the present invention is not limited to this structure, and phosphor layers 35 may be disposed in this region. However, because this region is a no-display region, it is preferable that no phosphor layer 35 is formed.

The structure of panel 10 is not limited to the above-mentioned one, but may be a structure having striped barrier ribs, for example.

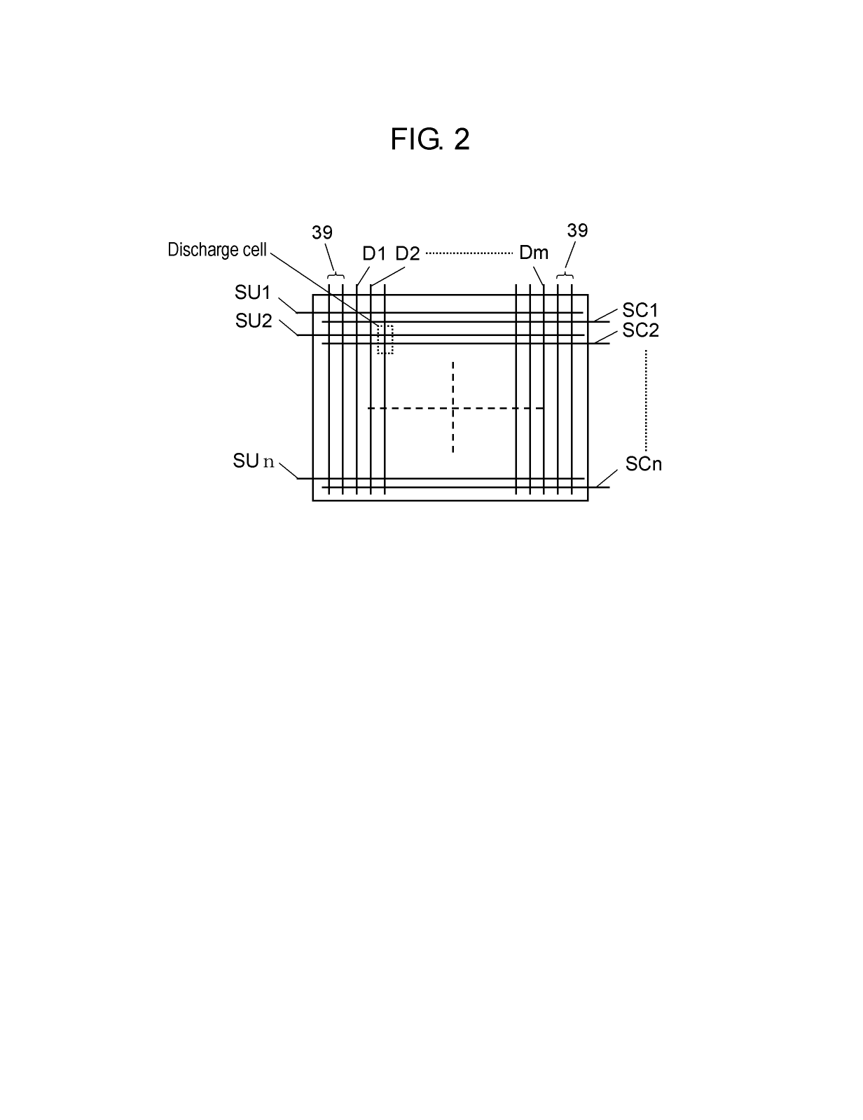

FIG. 2 is an electrode array diagram of panel 10 used for a plasma display apparatus in accordance with the first exemplary embodiment of the present invention. The display region of panel 10 has n scan electrode SC1 through scan electrode SCn (scan electrodes 22 in FIG. 1) and n sustain electrode SU1 through sustain electrode SUn (sustain electrodes 23 in FIG. 1) both extended in the horizontal direction (row direction), and m first data electrode D1 through first data electrode Dm (data electrodes 32 in FIG. 1) extended in the vertical direction (column direction).

A first discharge cell is formed in the part where a pair of scan electrode SCi (i is 1 through n) and sustain electrode SUi intersect with one first data electrode Dj (j is 1 through m). In other words, on one display electrode pair 24, m first discharge cells are formed and m/3 pixels are formed. Thus, m×n first discharge cells are formed in the discharge space, the region having m×n first discharge cells defines the display region of panel 10. In the panel where the number of pixels is 1920×1080, for example, m is 1920×3 and n is 1080.

In the no-display regions in the right and left peripheries of panel 10, a plurality of second discharge cells each of which has second data electrode 39 is formed. FIG. 2 shows an example where two second data electrodes 39 are disposed in each of the no-display regions in the right and left peripheries of panel 10.

Hereinafter, a first discharge cell is simply referred to as “discharge cell”, and a first data electrode is simply referred to as “data electrode”.

Next, a driving voltage waveform and operation for driving panel 10 are described schematically.

The plasma display apparatus of the present exemplary embodiment drives panel 10 by a subfield method. In this subfield method, the plasma display apparatus divides one field into a plurality of subfields on the time axis, and sets luminance weight for each subfield. Each field therefore includes a plurality of subfields. An image is displayed on panel 10 by controlling light emission and no light emission in each discharge cell of each subfield.

Each subfield has an initializing period, an address period, and a sustain period.

In the initializing period, an initializing operation is performed where initializing discharge is caused in the discharge cells and wall charge required for address discharge in the subsequent address period is formed on each electrode.

The initializing operation includes the following operations:
a forced initializing operation of forcibly causing initializing discharge in a discharge cell regardless of the operation of the immediately preceding subfield; and
a selective initializing operation of selectively causing initializing discharge only in the discharge cell having undergone address discharge in the address period and sustain discharge in the sustain period in the immediately preceding subfield.

In the forced initializing operation, increasing up-ramp waveform voltage and decreasing down-ramp waveform voltage are applied to scan electrodes 22, and initializing discharge is caused in all discharge cells in the image display region. Hereinafter, the initializing period for undergoing the forced initializing operation is referred to as “forced initializing period”, and the initializing period for undergoing the selective initializing operation is referred to as “selective initializing period”.

In the address period, scan pulses are applied to scan electrodes 22 and address pulses are selectively applied to data electrodes 32, thereby selectively causing address discharge in the discharge cell to emit light. Then, an address operation of producing wall charge for causing sustain discharge in the subsequent sustain period in the discharge cell is performed.

In the sustain period, a sustain operation is performed where as many sustain pulses as the number derived by multiplying the luminance weight of each subfield by a predetermined proportionality constant are alternately applied to scan electrodes 22 and sustain electrodes 23, sustain discharge is caused in the discharge cell having undergone address discharge in the immediately preceding address period, and light is emitted in the discharge cell. This proportionality constant is luminance magnification.

The luminance weight means the ratio between the luminances displayed in respective subfields, and as many sustain pulses as the number corresponding to the luminance weight are generated in each subfield in the sustain period. Therefore, in the subfield of luminance weight “8”, for example, light is emitted at a luminance about eight times that in the subfield of luminance weight “1” and light is emitted at a luminance about four times that in the subfield of luminance weight “2”.

When the luminance magnification is two, for example, in the sustain period of the subfield of luminance weight “2”, four sustain pulses are applied to scan electrodes 22 and four sustain pulses are applied to sustain electrodes 23. Therefore, the number of sustain pulses occurring in the sustain period is eight.

Thus, various gradation values can be displayed in each discharge cell and an image can be displayed on panel 10 by selectively emitting light in each subfield by controlling light emission and no light emission of each discharge cell in each subfield using a combination corresponding to the image signal. In the present exemplary embodiment, an example is described where one field is formed of 10 subfields (subfield SF1, subfield SF2, . . . , subfield SF10) and subfield SF1 through subfield SF10 have luminance weights of (1, 2, 3, 6, 11, 18, 30, 44, 60, 80), respectively.

The forced initializing operation is performed in the initializing period of one of the plurality of subfields, and the selective initializing operation is performed in the initializing periods of the other subfields. Hereinafter, a subfield having a forced initializing period is referred to as “forced initializing subfield”, and a subfield having a selective initializing period is referred to as “selective initializing subfield”.

In the present exemplary embodiment, the first subfield (subfield SF1) in each field is set as the forced initializing subfield, and the other subfields (subfield SF2 through subfield SF10) are set as the selective initializing subfields.

Thus, initializing discharge is caused in all discharge cells once for at least one field, so that the address operation after the forced initializing operation can be stabilized. The light emission related to no image display is only light emission following the discharge of the forced initializing operation in subfield SF1. Therefore, the luminance of black level, which is luminance in a black displaying region that does not cause sustain discharge, is therefore determined only by weak light emission in the forced initializing operation. An image of sharp contrast can be displayed on panel 10.

In the present invention, however, the number of subfields constituting one field and the luminance weight of each subfield are not limited to the above-mentioned numerical values. The subfield structure may be changed based on an image signal or the like.

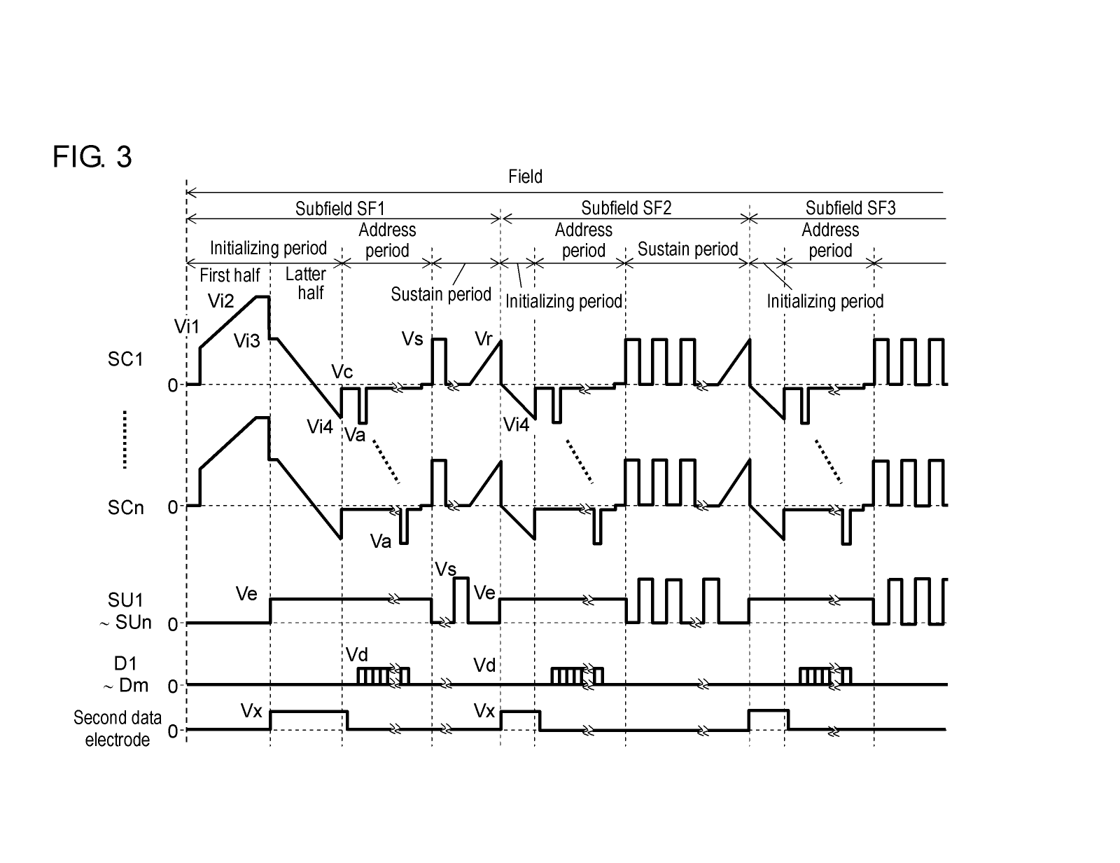

FIG. 3 is a diagram for schematically showing a driving voltage waveform applied to each electrode of panel 10 used for the plasma display apparatus in accordance with the first exemplary embodiment of the present invention. FIG. 3 shows driving voltage waveforms applied to scan electrode SC1 for firstly undergoing an address operation in the address period, scan electrode SCn (e.g. scan electrode SC 1080) for finally undergoing the address operation in the address period, sustain electrode SU1 through sustain electrode SUn, data electrode D1 through data electrode Dm, and second data electrodes 39. Each of scan electrode SCi, sustain electrode SUi, and data electrode Dk discussed later means the electrode that is selected from each kind of electrodes based on image data (which indicates lighting or no-lighting in each subfield).

FIG. 3 also shows driving voltage waveforms in three subfields, namely subfield SF1, subfield SF2, and subfield SF3. The forced initializing operation is performed in subfield SF1, and the selective initializing operation is performed in subfield SF2 and subfield SF3. Therefore, the waveform of the driving voltage applied to scan electrodes 22 in the initializing period in subfield SF1 differs from that in subfield SF2 and subfield SF3. The driving voltage waveforms in the other subfields are substantially the same as the driving voltage waveform in subfield SF2 and subfield SF3 except for the number of generated sustain pulses in the sustain period.

First, subfield SF1, which is a forced initializing subfield, is described.

In the first half of the initializing period of subfield SF1 where the forced initializing operation is performed, voltage 0 (V) is applied to data electrode D1 through data electrode Dm, and 0 (V) is also applied to sustain electrode SU1 through sustain electrode SUn. Voltage 0 (V) is also applied to second data electrodes 39.

To scan electrode SC1 through scan electrode SCn, voltage 0 (V) is applied, then voltage Vi1 is applied, and up-ramp waveform voltage (ramp voltage), which gently increases from voltage Vi1 to voltage Vi2, is applied. Voltage Vi1 is set at a voltage at which discharge does not occur in the discharge cell. Voltage Vi2 is set at a voltage higher than the voltage at which initializing discharge occurs in the discharge cell regardless of the operation of the immediately preceding subfield.

While this ramp voltage increases, feeble initializing discharge continuously occurs between scan electrode SC1 through scan electrode SCn and sustain electrode SU1 through sustain electrode SUn in each discharge cell, and feeble initializing discharge continuously occurs between scan electrode SC1 through scan electrode SCn and data electrode D1 through data electrode Dm in each discharge cell. Then, wall voltage of negative polarity is accumulated on scan electrode SC1 through scan electrode SCn, and wall voltage of positive polarity is accumulated on data electrode D1 through data electrode Dm and sustain electrode SU1 through sustain electrode SUn. The wall voltage on the electrodes means the voltage that is generated by the wall charge accumulated on the dielectric layer for covering the electrodes, the protective layer, or the phosphor layers.

At this time, feeble initializing discharge occurs between scan electrode SC1 through scan electrode SCn and sustain electrode SU1 through sustain electrode SUn in the second discharge cell, and feeble initializing discharge occurs between scan electrode SC1 through scan electrode SCn and second data electrodes 39 in the second discharge cell. Then, wall voltage of positive polarity is accumulated on second data electrodes 39. The details are described later.

In the latter half of the initializing period in subfield SF1, voltage Ve of positive polarity is applied to sustain electrode SU1 through sustain electrode SUn, and voltage 0 (V) is applied to data electrode D1 through data electrode Dm. At this time, voltage Vx of positive polarity is applied to second data electrodes 39.

Down-ramp waveform voltage (ramp voltage), which gently decreases from voltage Vi3 to voltage Vi4 of negative polarity, is applied to scan electrode SC1 through scan electrode SCn. Voltage Vi3 is set at a voltage lower than the discharge start voltage with respect to sustain electrode SU1 through sustain electrode SUn, and voltage Vi4 is set at a voltage exceeding the discharge start voltage.

While this ramp voltage is applied to scan electrode SC1 through scan electrode SCn, feeble initializing discharge occurs between scan electrode SC1 through scan electrode SCn and sustain electrode SU1 through sustain electrode SUn in each discharge cell, and feeble initializing discharge occurs between scan electrode SC1 through scan electrode SCn and data electrode D1 through data electrode Dm in each discharge cell. Then, the wall voltage of negative polarity accumulated on scan electrode SC1 through scan electrode SCn and the wall voltage of positive polarity accumulated on sustain electrode SU1 through sustain electrode SUn are reduced. The wall voltage of positive polarity accumulated on data electrode D1 through data electrode Dm is adjusted to a wall voltage suitable for an address operation by discharge of the excess part.

At this time, feeble initializing discharge occurs between scan electrode SC1 through scan electrode SCn and sustain electrode SU1 through sustain electrode SUn in the second discharge cell, and feeble initializing discharge occurs between scan electrode SC1 through scan electrode SCn and second data electrodes 39 in the second discharge cell. Then, wall voltage of positive polarity accumulated on second data electrodes 39 is reduced.

Thus, the forced initializing operation in the initializing period of subfield SF1 is completed, and wall charge required for the subsequent address operation is produced on each electrode in all discharge cells.

In the subsequent address period of subfield SF1, voltage Ve is applied to sustain electrode SU1 through sustain electrode SUn, voltage 0 (V) is applied to data electrode D1 through data electrode Dm, and voltage Vc is applied to scan electrode SC1 through scan electrode SCn. At this time, voltage 0 (V) is applied to second data electrodes 39.

Then, a scan pulse of negative polarity of voltage Va is applied to scan electrode SC1 in the first row, in which an address operation is firstly performed, and an address pulse of positive polarity of voltage Vd is applied to data electrode Dk of the discharge cell to emit light in the first row, of data electrode D1 through data electrode Dm.

In the discharge cell existing in the intersecting part of data electrode Dk to which address pulse voltage Vd is applied and scan electrode SC1 to which scan pulse voltage Va is applied, discharge occurs between data electrode Dk and scan electrode SC1.

Since voltage Ve is applied to sustain electrode SU1 through sustain electrode SUn, discharge occurring between data electrode Dk and scan electrode SC1 causes discharge also between sustain electrode SU1 and scan electrode SC1 that exist in a region crossing data electrode Dk. Thus, address discharge is caused in the discharge cell (this discharge cell is to emit light) to which scan pulse voltage Va and address pulse voltage Vd are applied simultaneously. Wall voltage of positive polarity is accumulated on scan electrode SC1, wall voltage of negative polarity is accumulated on sustain electrode SU1, and wall voltage of negative polarity is accumulated also on data electrode Dk.

Thus, the address operation in the discharge cell of the first row is completed. Address discharge does not occur in the discharge cell to which no address pulse voltage Vd has been applied.

Then, the address operation in the discharge cell of the second row is performed where scan pulse voltage Va is applied to scan electrode SC2 of the second row, and address pulse voltage Vd is applied to data electrode Dk corresponding to the discharge cell to emit light in the second row.

The similar address operation is sequentially performed until the discharge cell of the n-th row in the order of scan electrode SC3, scan electrode SC4, . . . , and scan electrode SCn. Thus, the address period of subfield SF1 is completed.

In this address period, discharge (accidental discharge) does not occur in the second discharge cell.

In the subsequent sustain period of subfield SF1, voltage 0 (V) is applied to data electrode D1 through data electrode Dm, and voltage 0 (V) is also applied to second data electrodes 39. Then, voltage 0 (V) is applied to sustain electrode SU1 through sustain electrode SUn, and a sustain pulse of positive polarity of voltage Vs is applied to scan electrode SC1 through scan electrode SCn.

In the discharge cell having undergone address discharge by application of sustain pulse voltage Vs, the voltage difference between scan electrode SCi and sustain electrode SUi is obtained by adding the difference between the wall voltage on scan electrode SCi and that on sustain electrode SUi to voltage Vs, and exceeds the discharge start voltage. Then, sustain discharge occurs between scan electrode SCi and sustain electrode SUi.

In the discharge cell having undergone sustain discharge, ultraviolet rays generated by this sustain discharge cause phosphor layer 35 to emit light. By this discharge, wall voltage of negative polarity is accumulated on scan electrode SCi, and wall voltage of positive polarity is accumulated on sustain electrode SUi. Wall voltage of positive polarity is also accumulated on data electrode Dk. In the discharge cell having undergone no address discharge in the address period, sustain discharge does not occur, and the wall voltage at the completion of the initializing operation is kept. Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge immediately before it, sustain discharge occurs again, and light is emitted in phosphor layer 35. Then, in this discharge cell, wall voltage of negative polarity is accumulated on sustain electrode SUi, and wall voltage of positive polarity is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, as many sustain discharges as the number corresponding to the luminance weight are continuously caused in the discharge cell having undergone the address discharge in the address period, and light is emitted in the discharge cell at a luminance corresponding to the luminance weight.

After the generation of the sustain pulses in the sustain period, in the state where voltage 0 (V) is applied to sustain electrode SU1 through sustain electrode SUn, data electrode D1 through data electrode Dm, and second data electrodes 39, ramp waveform voltage (ramp voltage), which gently increases from voltage 0 (V) to voltage Vr, is applied to scan electrode SC1 through scan electrode SCn.

While the ramp voltage is applied to scan electrode SC1 through scan electrode SCn, feeble discharge occurs in the discharge cell having undergone the sustain discharge. Charged particles generated by the feeble discharge are accumulated as wall charge on sustain electrode SUi and scan electrode SCi so as to reduce the voltage difference between sustain electrode SUi and scan electrode SCi. Thus, the wall voltages on scan electrode SCi and sustain electrode SUi are reduced while the wall voltage of positive polarity is left on data electrode Dk. In other words, unnecessary wall charge in the discharge cell is erased.

When the voltage applied to scan electrode SC1 through scan electrode SCn arrives at voltage Vr, the voltage applied to scan electrode SC1 through scan electrode SCn is decreased to voltage 0 (V). Thus, the sustain operation in the sustain period of subfield SF1 is completed.

Also in this sustain period, discharge (accidental discharge) does not occur in the second discharge cell.

Thus, subfield SF1 is completed.

Next, subfield SF2 as the selective initializing subfield is described.

In the initializing period of subfield SF2, voltage Ve is applied to sustain electrode SU1 through sustain electrode SUn, and voltage 0 (V) is applied to data electrode D1 through data electrode Dm. At this time, voltage Vx of positive polarity is applied to second data electrodes 39.

Ramp waveform voltage (ramp voltage), which gently decreases from a voltage (e.g. voltage 0 (V)) lower than the discharge start voltage to voltage Vi4 of negative polarity, is applied to scan electrode SC1 through scan electrode SCn. Voltage Vi4 is set at a voltage exceeding the discharge start voltage with respect to sustain electrode SU1 through sustain electrode SUn.

While this ramp voltage is applied to scan electrode SC1 through scan electrode SCn, feeble initializing discharge occurs in the discharge cell having undergone the sustain discharge in the sustain period of the immediately preceding subfield (subfield SF1 in FIG. 3). Then, this initializing discharge reduces the wall voltages on scan electrode SCi and sustain electrode SUi. The excess part of the wall voltage accumulated on data electrode Dk is discharged, and the wall voltage on data electrode Dk is adjusted to a wall voltage suitable for an address operation.

In the discharge cell having undergone no sustain discharge in the sustain period of the immediately preceding subfield (subfield SF1), initializing discharge does not occur, and the wall voltage is kept as it is.

Thus, the initializing operation in subfield SF2 becomes the selective initializing operation of selectively causing initializing discharge in the discharge cell that has undergone an address operation in the address period of the immediately preceding subfield.

At this time, generally, no discharge occurs in a second discharge cell. However, there are some second discharge cells into which charge leaks from peripheral discharge cells due to deformation or the like of barrier ribs 34 and in which excessive positive wall voltage causing accidental discharge is accumulated. In such second discharge cells, feeble discharge occurs to reduce the wall voltage.

Thus, the selective initializing operation in the initializing period of subfield SF2 is completed.

In the address period of subfield SF2, a driving voltage waveform similar to that in the address period of subfield SF1 is applied to each electrode. In other words, voltage 0 (V) is applied to data electrode D1 through data electrode Dm, voltage Ve is applied to sustain electrode SU1 through sustain electrode SUn, and voltage 0 (V) is applied to second data electrodes 39. Then, scan pulses of voltage Va are sequentially applied to scan electrode SC1 through scan electrode SCn, and an address pulse of voltage Vd is applied to data electrode Dk corresponding to the discharge cell to emit light. Thus, the address operation of accumulating wall voltage on each electrode of the discharge cell to emit light is performed.

In the subsequent sustain period, a driving voltage waveform similar to that in the sustain period of subfield SF1 is applied to each electrode except for the number of generated sustain pulses. In other words, voltage 0 (V) is applied to second data electrodes 39, as many sustain pulses as the number corresponding to the luminance weight are alternately applied to scan electrode SC1 through scan electrode SCn and sustain electrode SU1 through sustain electrode SUn, and sustain discharge is caused in the discharge cell that has undergone address discharge in the address period. Then, up-ramp waveform voltage, which gently increases from voltage 0 (V) to voltage Vr, is applied to scan electrode SC1 through scan electrode SCn, and the wall voltages on scan electrode SCi and sustain electrode SUi are reduced while the positive wall voltage is left on data electrode Dk.

In the initializing period and address period of each of subfield SF3 and later, driving voltage waveforms similar to those in the initializing period and address period of subfield SF2 are applied to each electrode. In the sustain period of each of subfield SF3 and later, a driving voltage waveform similar to that in subfield SF2 is applied to each electrode except for the number of sustain pulses generated in the sustain period.

The driving voltage waveform applied to each electrode of panel 10 of the present exemplary embodiment has been described schematically.

In the present exemplary embodiment, the following voltage values are applied to respective electrodes, for example. Voltage Vi1 is 150 (V), voltage Vi2 is 350 (V), voltage Vi3 is 200 (V), voltage Vi4 is −170 (V), voltage Vc is −50 (V), voltage Va is −200 (V), voltage Vs is 200 (V), voltage Vr is 200 (V), voltage Ve is 170 (V), voltage Vd is 60 (V), and voltage Vx is 60 (V).

In the initializing period of subfield SF1, the gradient of the up-ramp waveform voltage applied to scan electrode SC1 through scan electrode SCn is set at 1.5 (V/μsec). In the initializing period of each of subfield SF1 through subfield SF10, the gradient of the down-ramp waveform voltage applied to scan electrode SC1 through scan electrode SCn is set at −1.5 (V/μsec). At the end of the sustain period, the gradient of the up-ramp waveform voltage applied to scan electrode SC1 through scan electrode SCn is set at 10 (V/μsec).

The specific numerical values of the voltage values and gradients of the ramp waveform voltage are simply one example, and the voltage values and gradients of the present invention are not limited to the above-mentioned numerical values. Preferably, the voltage values and gradients are set optimally based on the discharge characteristics of the panel and the specification of the plasma display apparatus.

The above-mentioned subfield structure is simply one example in the present exemplary embodiment, and the present invention is not limited to this subfield structure. Preferably, the number of subfields constituting one field and the luminance weight of each subfield are set optimally in response to the characteristics of the panel and the specification of the plasma display apparatus.

Next, the reason why discharge (accidental discharge) in a second discharge cell can be prevented by applying the driving voltage waveform of FIG. 3 to second data electrodes 39 is described.

First, variation in wall voltage of a discharge cell in a display region is described.

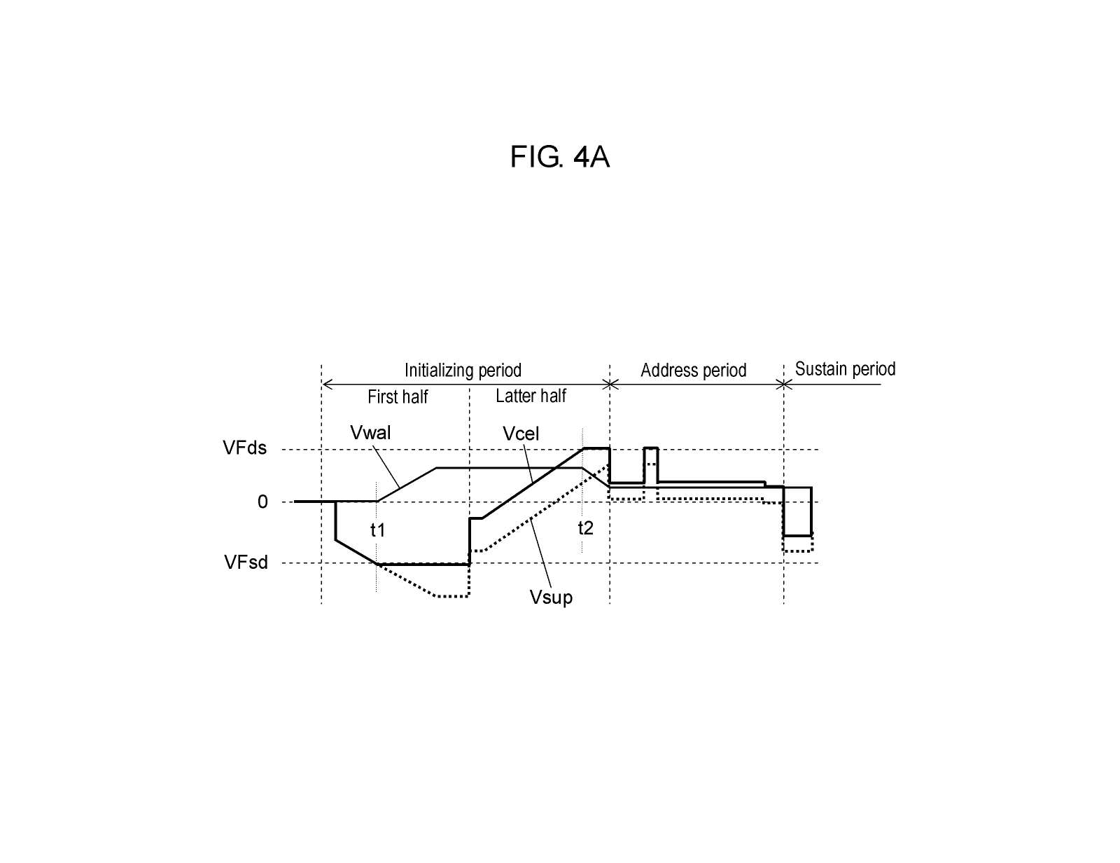

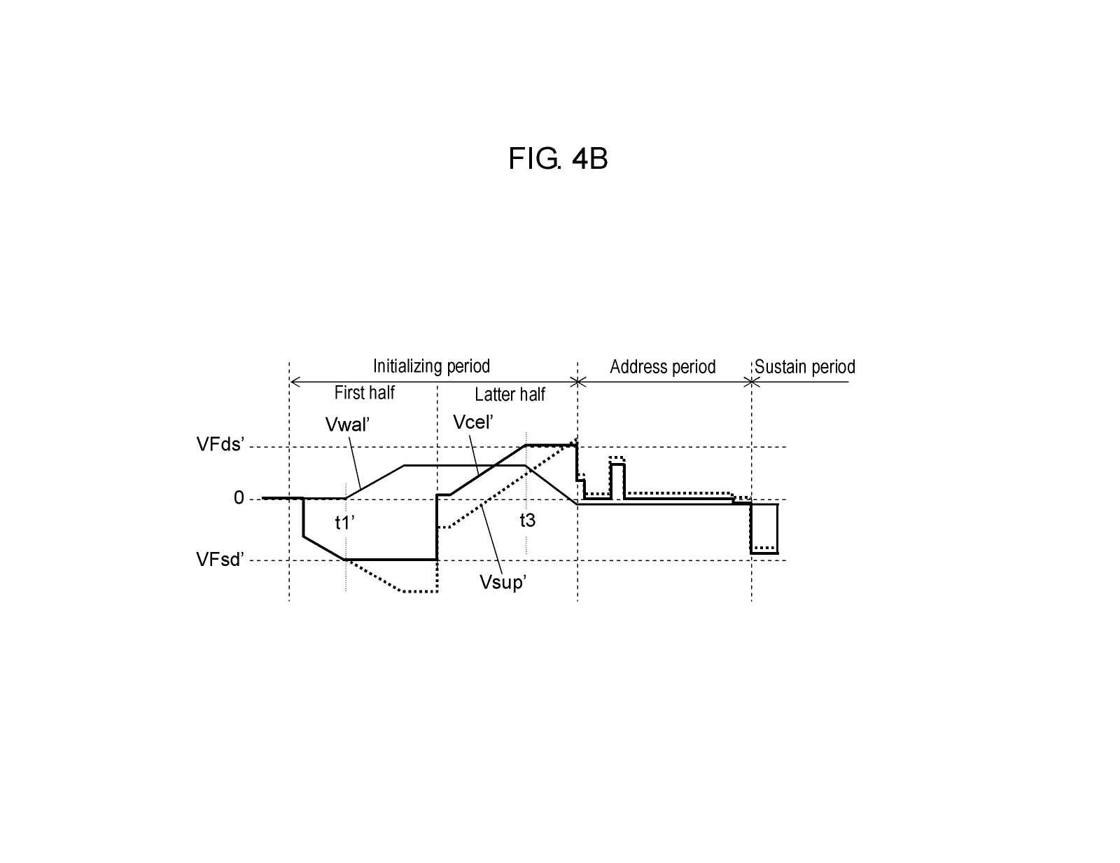

FIG. 4A is a diagram showing variation in wall voltage of a first discharge cell of the plasma display apparatus in accordance with the first exemplary embodiment of the present invention. FIG. 4A shows voltage with reference to the scan electrode 22 side.

In FIG. 4A, a broken line shows voltage Vsup, which is a voltage applied from the outside to the discharge cell. Voltage Vsup is difference between the voltage applied to data electrode 32 and the voltage applied to scan electrode 22.

In FIG. 4A, the thick solid line shows voltage Vcel. Voltage Vcel is substantially applied between data electrode 32 and scan electrode 22 in the discharge cell.

In FIG. 4A, the thin solid line shows voltage Vwal. Voltage Vwal is difference between the wall voltage accumulated on data electrode 32 and the wall voltage accumulated on scan electrode 22.

Discharge start voltage VFds is a discharge start voltage where data electrode 32 is used as a positive electrode and scan electrode 22 is used as a negative electrode. Discharge start voltage VFsd is a discharge start voltage where data electrode 32 is used as a negative electrode and scan electrode 22 is used as a positive electrode.

Protective layer 26 made of magnesium oxide of high electron emission performance is formed on the scan electrode 22 side, so that discharge start voltage VFds becomes lower than discharge start voltage VFsd.

Voltage Vcel that is substantially applied to the inside of the discharge cell is the sum of voltage Vsup applied from the outside and voltage Vwal by the wall charge. When voltage Vcel is a voltage between discharge start voltage VFds and discharge start voltage VFsd, no discharge occurs in the discharge cell.

In the first half of the initializing period, up-ramp waveform voltage is applied to scan electrode 22. When voltage Vcel in the discharge cell exceeds discharge start voltage VFsd at time t1, feeble discharge occurs in the discharge cell. Then, wall voltage Vwal for cancelling voltage Vsup is accumulated in the discharge cell, and voltage Vcel in the discharge cell is kept at a voltage substantially equal to discharge start voltage VFsd.

In the latter half of the initializing period, down-ramp waveform voltage is applied to scan electrode 22. Wall voltage Vwal is accumulated in the discharge cell, wall voltage Vwal is added to voltage Vsup applied from the outside. When voltage Vcel in the discharge cell exceeds discharge start voltage VFds at time t2, feeble discharge occurs in the discharge cell. Then, wall voltage Vwal for cancelling voltage Vsup is accumulated in the discharge cell, and voltage Vcel in the discharge cell is kept at a voltage substantially equal to discharge start voltage VFds.

When a scan pulse is applied to scan electrode 22 in the address period, voltage Vcel in the discharge cell becomes substantially equal to discharge start voltage VFds. Therefore, when an address pulse is applied to data electrode 32, voltage Vcel in the discharge cell significantly exceeds discharge start voltage VFds, and address discharge occurs in the discharge cell.

Next, variation in wall voltage of a second discharge cell in a no-display region is described.

FIG. 4B is a diagram showing variation in wall voltage of a second discharge cell of the plasma display apparatus in accordance with the first exemplary embodiment of the present invention. Similarly to FIG. 4A, FIG. 4B shows voltage with reference to the scan electrode 22 side.

In FIG. 4B, a broken line shows voltage Vsup′, which is a voltage applied from the outside to the second discharge cell. Voltage Vsup′ is difference between the voltage applied to data electrode 32 and the voltage applied to scan electrode 22.

In FIG. 4B, the thick solid line shows voltage Vcel′. Voltage Vcel′ is substantially applied between data electrode 32 and scan electrode 22 in the discharge cell.

In FIG. 4B, the thin solid line shows voltage Vwal′. Voltage Vwal′ is difference between the wall voltage accumulated on second data electrode 39 and the wall voltage accumulated on scan electrode 22.

Discharge start voltage VFds′ is a discharge start voltage where second data electrode 39 is used as a positive electrode and scan electrode 22 is used as a negative electrode. Discharge start voltage VFsd′ is a discharge start voltage where second data electrode 39 is used as a negative electrode and scan electrode 22 is used as a positive electrode.

In the first half of the initializing period, up-ramp waveform voltage is applied to scan electrode 22. When voltage Vcel′ in the second discharge cell exceeds discharge start voltage VFsd′ at time t1', feeble discharge occurs in the second discharge cell. Then, wall voltage Vwal′ for cancelling voltage Vsup′ applied from the outside is accumulated in the second discharge cell, and voltage Vcel′ in the second discharge cell is kept at a voltage substantially equal to discharge start voltage VFsd'.

The operation of the second discharge cell described until now is substantially the same as the operation of the first discharge cell of FIG. 4A.

In the latter half of the initializing period, down-ramp waveform voltage is applied to scan electrode 22. At this time, voltage Vx of positive polarity is applied to second data electrode 39. Therefore, voltage Vsup′ applied from the outside to the second discharge cell is significantly different from voltage Vsup applied from the outside to the first discharge cell in the display region.

In the second discharge cell, wall voltage Vwal′ is added to voltage Vsup′ applied from the outside, and voltage Vcel′ exceeds discharge start voltage VFds′ at time t3 earlier than time t2. Thus, feeble discharge occurs in the second discharge cell. Then, wall voltage Vwal′ for cancelling voltage Vsup′ applied from the outside is accumulated in the second discharge cell, and voltage Vcel′ in the second discharge cell is kept at a voltage substantially equal to discharge start voltage VFds′.

Then, in the address period, voltage Vx of positive polarity is not applied to second data electrode 39, and a scan pulse is applied to scan electrode 22. Therefore, voltage Vcel′ in the second discharge cell does not arrive at discharge start voltage VFds′. In the second discharge cell, therefore, discharge (accidental discharge) does not occur in the address period.

In the second discharge cell, discharge does not occur in the address period, so that voltage Vcel′ in the second discharge cell does not exceed discharge start voltage VFds′ and discharge start voltage VFsd′ in the sustain period either. In the second discharge cell, therefore, sustain discharge does not occur in the sustain period.

Thus, in the present exemplary embodiment, in the initializing period, down-ramp waveform voltage is applied to scan electrode 22, and voltage Vx of positive polarity is applied to second data electrode 39, thereby actively causing discharge between scan electrode 22 and second data electrode 39. Thus, in the address period and sustain period, voltage Vcel′ in the second discharge cell does not arrive at discharge start voltage VFds′ and discharge start voltage VFsd′, so that discharge (accidental discharge) does not occur in the second discharge cell and unnecessary light emission does not occur either.

As discussed above, in the second discharge cell, the driving voltage waveform is set so that, when a scan pulse is applied to scan electrode 22 in the address period, voltage Vcel′ in the second discharge cell does not arrive at discharge start voltage VFds′. Thus, in the second discharge cell, address discharge can be prevented from occurring in the address period.

While, in the first discharge cell, the driving voltage waveform is set so that, when a scan pulse is applied to scan electrode 22, voltage Vcel in the discharge cell becomes substantially equal to discharge start voltage VFds. Thus, in the first discharge cell, address discharge can be caused in the address period.

The condition for performing such driving is collectively described below.

First voltage V1 is assumed to be the voltage derived by subtracting the voltage applied to first data electrode 32 from the voltage applied to second data electrode 39 when the down-ramp waveform voltage is applied to scan electrode 22 in the initializing period. Second voltage V2 is assumed to be the voltage derived by subtracting the low-voltage-side voltage of the address pulse applied to first data electrode 32 from the voltage applied to second data electrode 39 in the address period. At this time, in at least one subfield, first voltage V1 is set to be higher than second voltage V2.

In the present exemplary embodiment, when the down-ramp waveform voltage is applied to scan electrode 22 in the initializing periods of all subfields, voltage Vx of positive polarity is applied to second data electrode 39, and voltage 0 (V) equal to the low-voltage-side voltage of the address pulse is applied to first data electrode 32. Therefore, first voltage V1 is expressed by the following equation:

first voltage V1=voltage Vx−voltage 0 (V)=voltage Vx.

In the address period, the voltage applied to second data electrode 39 is voltage 0 (V), and the low-voltage-side voltage of the address pulse applied to first data electrode 32 is also voltage 0 (V). Therefore, second voltage V2 is expressed by the following equation:

second voltage V2=voltage 0 (V)−voltage 0 (V)=voltage 0 (V).

Therefore, it is recognized that first voltage V1 is set to be higher than the second voltage in all subfields.

Next, a driving circuit and operation for driving panel 10 are described.

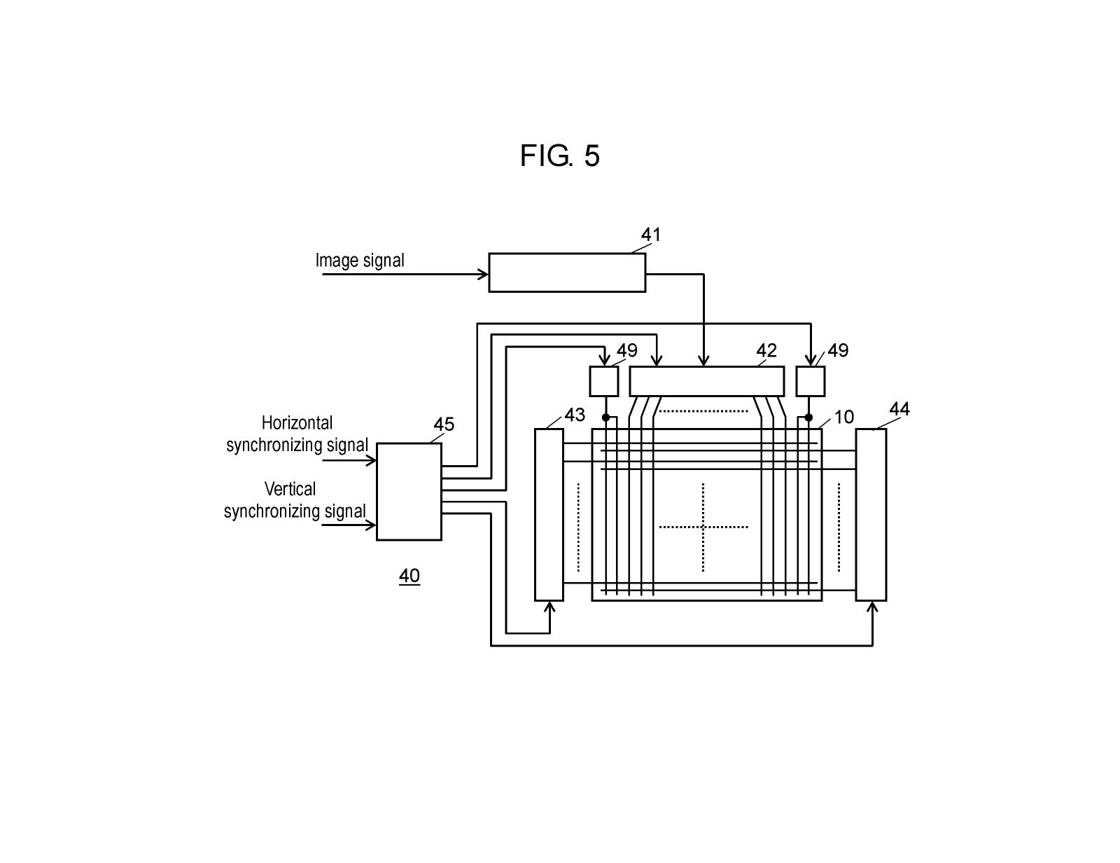

FIG. 5 is a diagram for schematically showing one example of circuit blocks constituting plasma display apparatus 40 in accordance with the first exemplary embodiment of the present invention.

Plasma display apparatus 40 of the present exemplary embodiment includes panel 10 and a driving circuit for driving panel 10. The driving circuit includes the following elements:
image signal processing circuit 41;
data electrode driver circuit 42;
scan electrode driver circuit 43;
sustain electrode driver circuit 44;
timing generation circuit 45;
second data electrode driver circuit 49; and
a power supply circuit (not shown) for supplying power required for each circuit block.

Image signal processing circuit 41 sets a gradation value for each discharge cell based on an input image signal. Then, image signal processing circuit 41 converts the gradation value into image data that indicates lighting or no-lighting in each subfield (in this data, lighting and no-lighting correspond to “1” and “0” of a digital image). In other words, image signal processing circuit 41 converts the image signal for each field into image data that indicates lighting or no-lighting in each subfield. Then, image signal processing circuit 41 transmits the image data to data electrode driver circuit 42.

The image signal input to image signal processing circuit 41 includes a red image signal, a green image signal, and a blue image signal, and image signal processing circuit 41 sets each gradation value of R, G, and B to each discharge cell based on the image signal of each color. When the input image signal includes a luminance signal (Y signal) and a chroma signal (C signal, R-Y signal and B-Y signal, or u signal and v signal), image signal processing circuit 41 calculates the red image signal, green image signal, and blue image signal based on the luminance signal and chroma signal, and then sets each gradation value (gradation value represented in one field) of R, G, and B to each discharge cell. Image signal processing circuit 41 converts each gradation value of R, G, and B set to each discharge cell into image data that indicates lighting or no lighting in each subfield.

Timing generation circuit 45 generates various timing signals for controlling the operation of each circuit block based on a horizontal synchronizing signal and vertical synchronizing signal. Timing generation circuit 45 supplies the generated timing signals to respective circuit blocks (data electrode driver circuit 42, scan electrode driver circuit 43, sustain electrode driver circuit 44, second data electrode driver circuit 49, and image signal processing circuit 41).

Scan electrode driver circuit 43 has an initializing waveform generation circuit, a sustain pulse generation circuit, and a scan pulse generation circuit (not shown in FIG. 5). Scan electrode driver circuit 43 generates driving voltage waveforms based on a timing signal supplied from timing generation circuit 45, and applies them to scan electrode SC1 through scan electrode SCn, respectively. The initializing waveform generation circuit generates initializing waveforms applied to scan electrode SC1 through scan electrode SCn in the initializing period based on the timing signal. The sustain pulse generation circuit generates sustain pulses applied to scan electrode SC1 through scan electrode SCn in the sustain period based on the timing signal.

The scan pulse generation circuit has a plurality of scan electrode driver ICs (scan ICs), and generates scan pulses applied to scan electrode SC1 through scan electrode SCn in the address period based on the timing signal.

Sustain electrode driver circuit 44 has a sustain pulse generation circuit and a circuit (not shown in FIG. 5) for generating voltage Ve. Sustain electrode driver circuit 44 generates driving voltage waveforms based on a timing signal supplied from timing generation circuit 45, and applies them to sustain electrode SU1 through sustain electrode SUn, respectively. In the sustain period, sustain electrode driver circuit 44 generates sustain pulses based on the timing signal and applies them to sustain electrode SU1 through sustain electrode SUn, respectively.

Data electrode driver circuit 42 generates address pulses corresponding to data electrode D1 through data electrode Dm based on the image data of each color output from image signal processing circuit 41 and the timing signal supplied from timing generation circuit 45. Data electrode driver circuit 42 applies the address pulses to data electrode D1 through data electrode Dm in the address period, respectively.

While down-ramp waveform voltage is applied to scan electrodes 22 in the initializing period, second data electrode driver circuit 49 applies voltage Vx of positive polarity to second data electrodes 39. In the address period, second data electrode driver circuit 49 applies a voltage lower than voltage Vx of positive polarity to second data electrodes 39. In the present exemplary embodiment, as the voltage lower than voltage Vx of positive polarity, voltage 0 (V) is applied to second data electrodes 39 in the address period. In the present exemplary embodiment, voltage 0 (V) is applied to second data electrodes 39 also in the sustain period.

Next, data electrode driver circuit 42 and second data electrode driver circuit 49 are described.

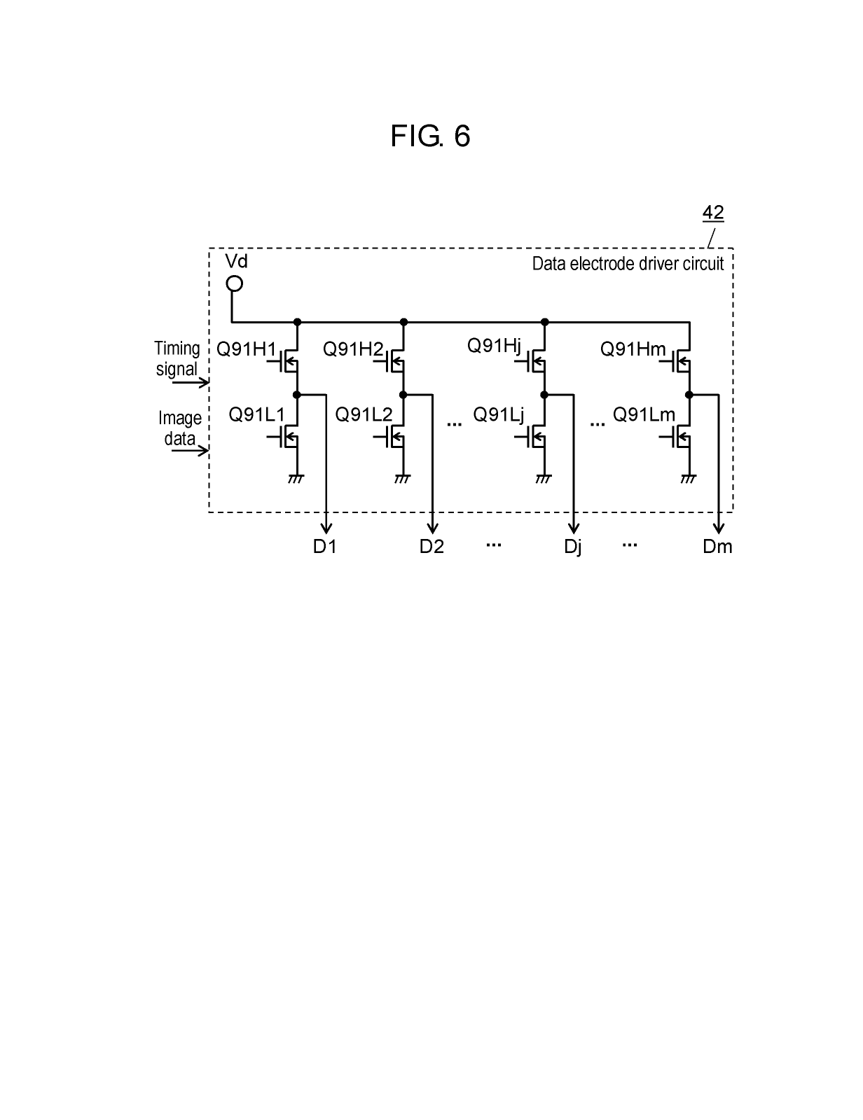

FIG. 6 is a circuit diagram for schematically showing the configuration of data electrode driver circuit 42 for driving first data electrode 32 of plasma display apparatus 40 in accordance with the first exemplary embodiment of the present invention.

In FIG. 6, the details of the signal routes of the control signals input into respective circuits (timing signal supplied from timing generation circuit 45 and image data supplied from image signal processing circuit 41) are omitted.

Data electrode driver circuit 42 has switching element Q91H1 through switching element Q91Hm and switching element Q91L1 through switching element Q91Lm. Based on the image data (the details of the image data are omitted in FIG. 6), data electrode driver circuit 42 sets switching element Q91Lj at ON to apply voltage 0 (V) to data electrode Dj and sets switching element Q91Hj at ON to apply voltage Vd to data electrode Dj.

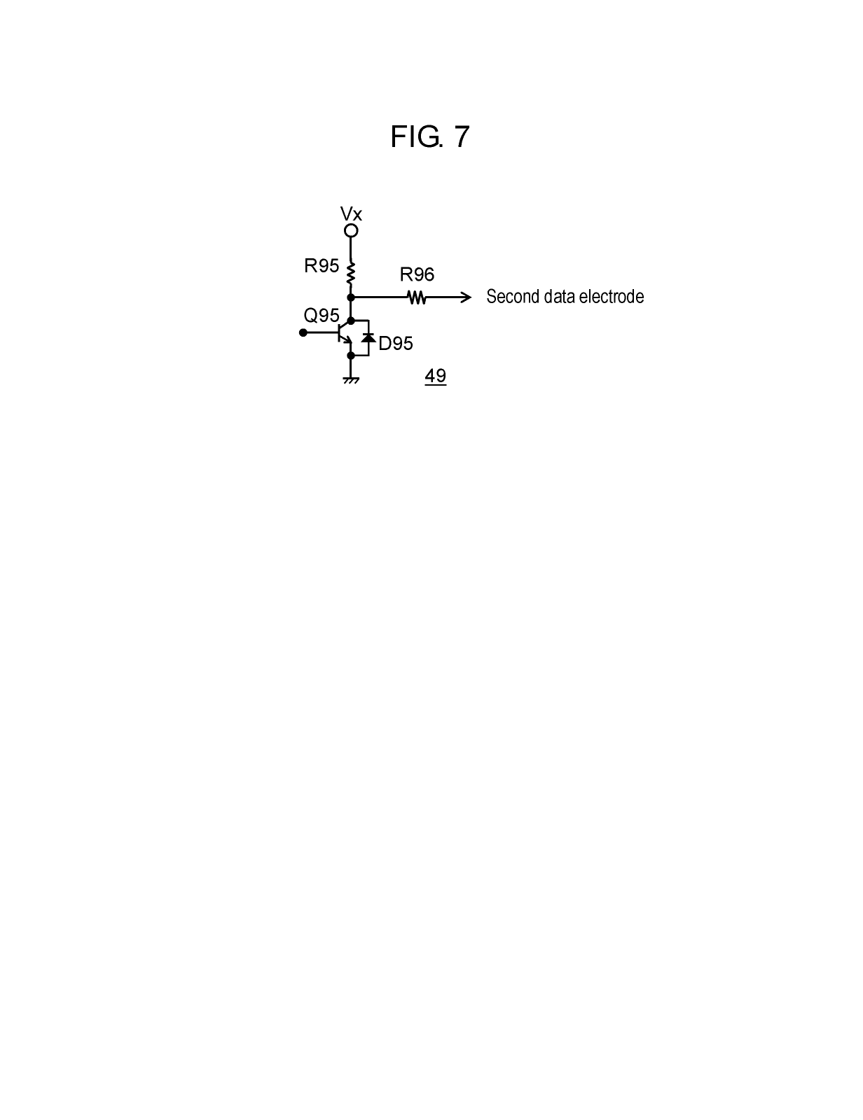

FIG. 7 is a circuit diagram for schematically showing the configuration of second data electrode driver circuit 49 for driving second data electrode 39 of plasma display apparatus 40 in accordance with the first exemplary embodiment of the present invention.

Second data electrode driver circuit 49 has switching element Q95, diode D95, resistor R95, and resistor R96.

One terminal of resistor R95 is connected to a power supply of voltage Vx. The other terminal is connected to second data electrode 39 via resistor R96, and is connected to ground potential of voltage 0 (V) via switching element Q95. When switching element Q95 is set at ON, voltage 0 (V) is applied to second data electrode 39. When switching element Q95 is set at OFF, voltage Vx is applied to second data electrode 39.

Resistor R96 is disposed so that excessive current does not flow in switching element Q95. Diode D95 is disposed so that voltage of reversed polarity is not applied to switching element Q95.

In the present exemplary embodiment, resistor R95 is set at 22 (kΩ), and resistor R96 is set at 1 (kΩ). However, preferably, these values are set optimally based on the specification of panel 10 and the specification of switching element Q95.

### Second Exemplary Embodiment

In the first exemplary embodiment, an example has been described where, when down-ramp waveform voltage is applied to scan electrodes 22 in the initializing periods of all subfields, voltage Vx of positive polarity is applied to second data electrodes 39 and voltage 0 (V) equal to the low-voltage-side voltage of the address pulse is applied to first data electrodes 32. In the first exemplary embodiment, therefore, voltage Vx of positive polarity that is higher than the voltage applied to first data electrodes 32 is applied to second data electrodes 39 in the initializing periods of all subfields. However, the present invention is not limited to this configuration.

In the second exemplary embodiment, an example is described where, in the initializing period of one subfield, voltage Vx of positive polarity that is higher than the voltage applied to first data electrodes 32 is applied to second data electrodes 39.

In the plasma display apparatus of the first exemplary embodiment, panel 10 is driven while a forced initializing operation is performed in all discharge cells in the initializing period of subfield SF1. In the plasma display apparatus of the second exemplary embodiment, panel 10 is driven while a forced initializing operation is performed once per a plurality of fields in each discharge cell. In the plasma display apparatus of the second exemplary embodiment, therefore, there are both discharge cells that undergo the forced initializing operation and discharge cells that undergo no forced initializing operation in the initializing period of subfield SF1.

First, a driving voltage waveform for driving panel 10 and the outline of the operation in the second exemplary embodiment are described.

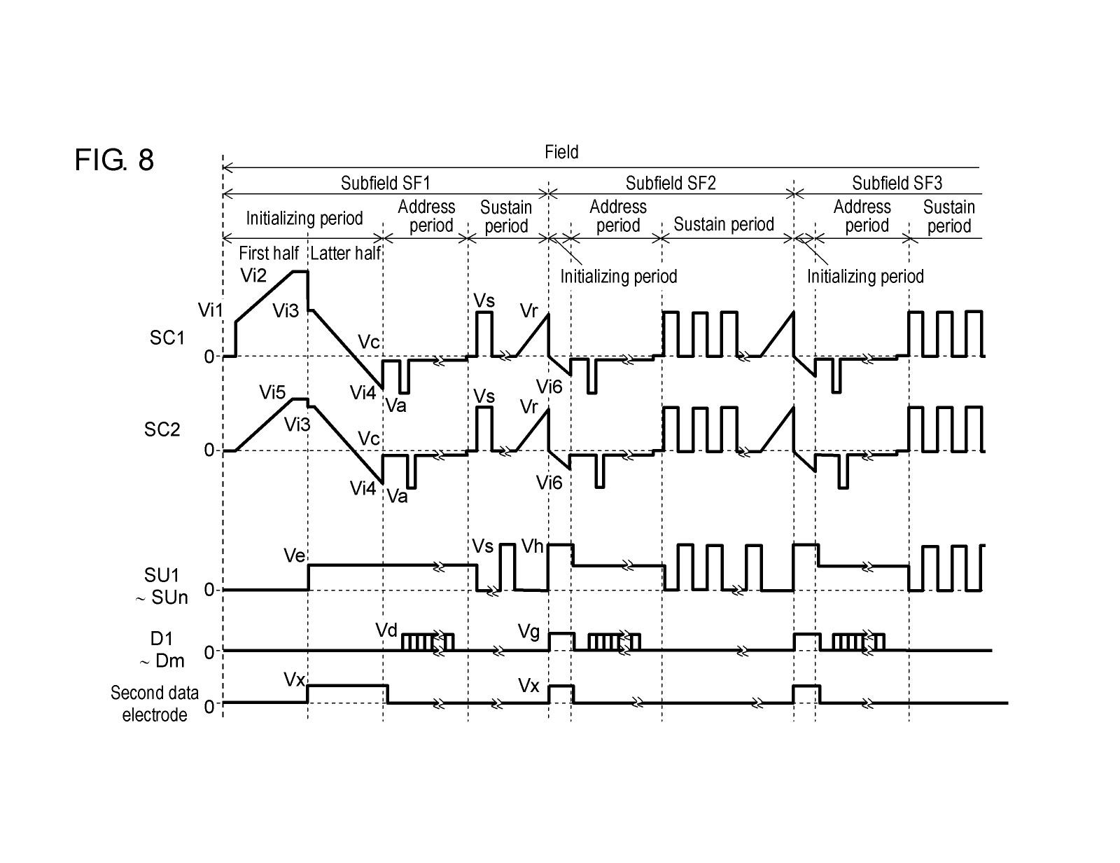

FIG. 8 is a diagram for schematically showing a driving voltage waveform applied to each electrode of a panel used for the plasma display apparatus in accordance with the second exemplary embodiment of the present invention.

FIG. 8 shows driving voltage waveforms applied to scan electrode SC1 for firstly undergoing an address operation in the address period, scan electrode SC2 for secondly undergoing an address operation in the address period, sustain electrode SU1 through sustain electrode SUn, data electrode D1 through data electrode Dm, and second data electrodes 39. FIG. 8 shows driving voltage waveforms of three subfields, namely subfield SF1, subfield SF2, and subfield SF3.

FIG. 8 shows an example where a forced initializing operation is performed in a discharge cell having scan electrode SC1 and no forced initializing operation is performed in a discharge cell having scan electrode SC2.

In the present exemplary embodiment, in the initializing period, the same driving voltage waveform as that of scan electrode 22 of the discharge cell that undergoes the forced initializing operation is applied to scan electrode 22 of the second discharge cell existing in the same row as that of the discharge cell that undergoes the forced initializing operation. The same driving voltage waveform as that of scan electrode 22 of the discharge cell that does not undergo the forced initializing operation is applied to scan electrode 22 of the second discharge cell existing in the same row as that of the discharge cell that does not undergo the forced initializing operation.

First, subfield SF1 is described.

In the first half of the initializing period of subfield SF1, voltage 0 (V) is applied to data electrode D1 through data electrode Dm, and 0 (V) is also applied to sustain electrode SU1 through sustain electrode SUn. Voltage 0 (V) is also applied to second data electrodes 39.

To scan electrode SC1 that undergoes the forced initializing, voltage 0 (V) is applied, then voltage Vil is applied, and up-ramp waveform voltage (ramp voltage), which gently increases from voltage Vi1 to voltage Vi2, is applied. Voltage Vi1 is set at a voltage at which discharge does not occur in the discharge cell. Voltage Vi2 is set at a voltage higher than the voltage at which initializing discharge occurs in the discharge cell regardless of the operation of the immediately preceding subfield.

While this ramp voltage increases, feeble initializing discharge continuously occurs between scan electrode SC1 and sustain electrode SU1, and feeble initializing discharge continuously occurs between scan electrode SC1 and data electrode D1 through data electrode Dm. Then, wall voltage of negative polarity is accumulated on scan electrode SC1, and wall voltage of positive polarity is accumulated on data electrode D1 through data electrode Dm and sustain electrode SU1. Further, priming that shortens the discharge delay time of address discharge occurs also.

Feeble initializing discharge occurs between scan electrode SC1 and sustain electrode SU1 of the second discharge cell existing on scan electrode SC1, and feeble initializing discharge occurs between scan electrode SC1 and second data electrodes 39. Then, wall voltage of positive polarity is accumulated on second data electrodes 39.

To scan electrode SC2 that does not undergo the forced initializing operation, voltage Vil is not applied, but up-ramp waveform voltage, which gently increases from voltage 0 (V) to voltage Vi5, is applied. Voltage Vi5 is set at a voltage at which discharge does not occur. Therefore, discharge does not occur in the discharge cell existing on scan electrode SC2.

Similarly, discharge does not occur in the second discharge cell existing on scan electrode SC2 either.

In the latter half of the initializing period in subfield SF1, voltage Ve of positive polarity is applied to sustain electrode SU1 through sustain electrode SUn, and voltage 0 (V) is applied to data electrode D1 through data electrode Dm. At this time, voltage Vx of positive polarity is applied to second data electrodes 39.

Down-ramp waveform voltage (ramp voltage), which gently decreases from voltage Vi3 to voltage Vi4 of negative polarity, is applied to scan electrode SC1 through scan electrode SCn. Voltage Vi3 is set at a voltage lower than the discharge start voltage with respect to sustain electrode SU1 through sustain electrode SUn, and voltage Vi4 is set at a voltage exceeding the discharge start voltage.

While this ramp voltage is applied to scan electrode SC1 through scan electrode SCn, feeble initializing discharge occurs in the following discharge cells:
a discharge cell that has undergone the feeble initializing discharge in the first half of the initializing period of subfield SF1; and
a discharge cell that has undergone sustain discharge in subfield SF10 of the preceding field, which is the immediately preceding subfield, and has accumulated excess wall charge.

In the discharge cell having undergone the initializing discharge, wall voltage of negative polarity on scan electrode 22 and wall voltage of positive polarity on sustain electrode 23 are reduced, the wall voltage of positive polarity on data electrode D1 through data electrode Dm is adjusted to a wall voltage suitable for the address operation by discharge of the excess part. Further, priming that shortens the discharge delay time of address discharge occurs also.

Also in the second discharge cell that has undergone the feeble initializing discharge in the first half of the initializing period of subfield SF1, feeble initializing discharge occurs, and wall voltages on scan electrode 22 and sustain electrode 23 in the second discharge cell are reduced.

In the discharge cell that has not undergone sustain discharge in subfield SF10 of the preceding field, which is the immediately preceding subfield, and has not undergone initializing discharge in the first half of the initializing period of subfield SF1 either, initializing discharge does not occur and the wall voltage is kept as it is.

Similarly, discharge does not occur in the second discharge cell that has not undergone initializing discharge in the first half of the initializing period of subfield SF1.

Thus, the initializing operation in the initializing period of subfield SF1 is completed. In the present exemplary embodiment, there are both discharge cells that undergo the forced initializing operation and discharge cells that undergo the selective initializing operation in the initializing period of subfield SF1.

In the subsequent address period and sustain period of subfield SF1, driving voltage waveforms similar to those in the address period and sustain period of subfield SF1 of the first exemplary embodiment are applied to each electrode.

Thus, subfield SF1 is completed.

Next, subfield SF2, which is a selective initializing subfield, is described.

In the initializing period of subfield SF2, voltage Vg of positive polarity is applied to data electrode D1 through data electrode Dm, voltage Vx of positive polarity is also applied to second data electrodes 39. Voltage Vh higher than voltage Ve is applied to sustain electrode SU1 through sustain electrode SUn. Ramp waveform voltage (ramp voltage), which gently decreases from a voltage (e.g. voltage 0 (V)) lower than the discharge start voltage to voltage Vi6, is applied to scan electrode SC1 through scan electrode SCn. Voltage Vi6 is set to be the same level as the sum of voltage Vi4 and voltage Vg.

While this ramp voltage is applied to scan electrode SC1 through scan electrode SCn, feeble initializing discharge occurs in the discharge cell having undergone sustain discharge in the sustain period in the immediately preceding subfield (subfield SF1 in FIG. 8). The wall voltages on scan electrode SCi and sustain electrode SUi are reduced by this initializing discharge. The wall voltage on data electrode Dk is adjusted to a wall voltage suitable for the address operation by discharge of the excess part of the wall voltage on data electrode Dk.

In the discharge cell that has not undergone sustain discharge in the sustain period of the immediately preceding subfield (subfield SF1), initializing discharge does not occur and the wall voltage is kept as it is.

At this time, generally, no discharge occurs in the second discharge cells. However, there are some second discharge cells into which charge leaks from peripheral discharge cells due to deformation or the like of barrier ribs 34 and in which excessive positive wall voltage causing accidental discharge is accumulated. In such second discharge cells, feeble discharge occurs to reduce the wall voltage.

Thus, the selective initializing operation in the initializing period of subfield SF2 is completed.

In the address period of subfield SF2, a driving voltage waveform similar to that in the address period of subfield SF1 is applied to each electrode. In the subsequent sustain period, a driving voltage waveform similar to that in the sustain period of subfield SF1 is applied to each electrode except for the number of generated sustain pulses.

In each of subfield SF3 and later, a driving voltage waveform similar to that in subfield SF2 is applied to each electrode except for the number of sustain pulses generated in the sustain period.

In the present exemplary embodiment, voltage values that are applied to respective electrodes are set at the same values as the voltage values of the first exemplary embodiment. The set voltage values are described below. Voltage Vi5 is 200 (V), voltage Vi6 is −110 (V), voltage Vg is 60 (V), voltage Vh is 200 (V).

When voltage Vg is voltage Vd, driving voltage waveforms applied to data electrode D1 through data electrode Dm of FIG. 8 can be generated using data electrode driver circuit 42 of FIG. 6. When voltage Vg is different from voltage Vd, driving voltage waveforms applied to data electrode D1 through data electrode Dm of FIG. 8 can be generated using a circuit that has a power supply for generating voltage Vg and a switching element capable of switching between voltage Vg and voltage Vd and applying the voltage to switching element Q91H1 through switching element Q91Hm. When voltage Vh is voltage Vs, a pulse of voltage Vh can be generated using a circuit for generating a sustain pulse that is disposed in sustain electrode driver circuit 44, so that driving voltage waveforms applied to sustain electrode SU1 through sustain electrode SUn of FIG. 8 can be generated using sustain electrode driver circuit 44.

Specific numerical values such as these voltage values and gradients of ramp waveform voltages are simply one example, and the voltage values and gradients of the present invention are not limited to the above-mentioned numerical values. Preferably, the voltage values and gradients are set optimally based on the discharge characteristics of the panel or the specification of the plasma display apparatus.

Next, the relationship between scan electrode 22 to undergo a forced initializing operation and a field is described. In the present exemplary embodiment, scan electrode 22 to undergo a forced initializing operation is set based on the following rule. Hereinafter, scan electrode 22 to undergo a forced initializing operation is also referred to as “specific scan electrode”.

When the forced initializing operation is performed in one scan electrode 22 once for one of N temporally continuous fields (N is a natural number), the N temporally continuous fields are set as one field group. N continuously arranged scan electrodes 22 are set as one scan electrode group. Under this condition, rule 1 and rule 2 are defined as below.

(Rule 1) The number of fields to undergo a forced initializing operation in one scan electrode 22 is one in each field group.

(Rule 2) The number of scan electrodes 22 to undergo a forced initializing operation in one field is one in each scan electrode group. When N is 5 or larger, the following rule 3 is defined.

(Rule 3) In scan electrode SCi-1 and scan electrode SCi+1 that are adjacent to scan electrode SCi to undergo a forced initializing operation in one field, the forced initializing operation is not performed in that field, the next field, or more.

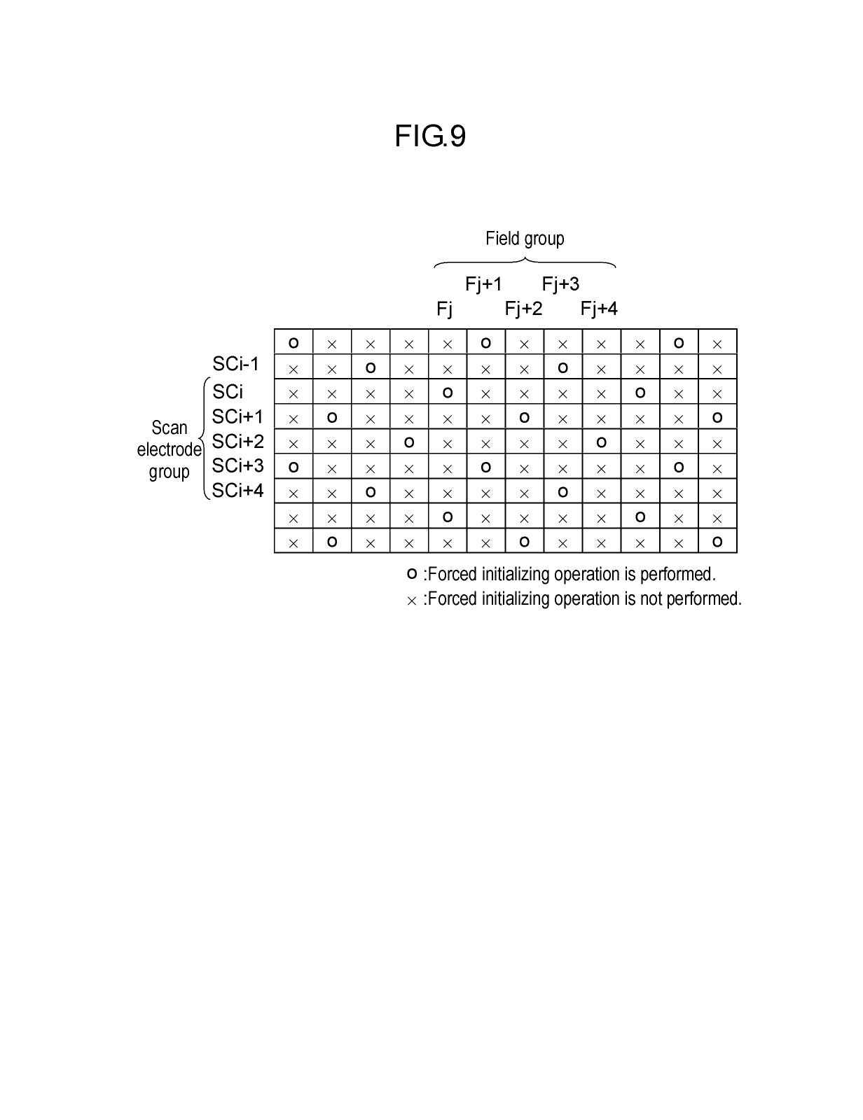

Next, a generation pattern of the forced initializing operation based on these rules is described. FIG. 9 is a diagram showing one example of a generation pattern of a forced initializing operation and selective initializing operation in accordance with the second exemplary embodiment of the present invention. In FIG. 9, the horizontal axis shows field, and the vertical axis shows scan electrode 22.

FIG. 9 shows one example when N is set at five and five temporally continuous fields are set as one field group. Therefore, in the example of FIG. 9, one field group is constituted by field Fj, field Fj+1, field Fj+2, field Fj+3, and field Fj+4, and one scan electrode group is constituted by scan electrode SCi, scan electrode SCi+1, scan electrode SCi+2, scan electrode SCi+3, and scan electrode SCi+4.

“O” of FIG. 9 shows that the forced initializing operation is performed in the initializing period of subfield SF1, and “×” shows that the forced initializing operation is not performed in the initializing period of subfield SF1

As shown in FIG. 9, in scan electrode SCi, the forced initializing operation is performed in one field of each field group. In other words, in scan electrode SCi, the forced initializing operation is performed once for each field group. This is established also in other scan electrodes 22 (rule 1).

Thus, the number of forced initializing operations is decreased to ⅕ of that when the forced initializing operation is performed in all discharge cells in each field. Therefore, light emission caused by the forced initializing operation is also reduced to ⅕, and the luminance of black level of a display image can be reduced correspondingly.

As shown in FIG. 9, in field Fj, the forced initializing operation is performed in one scan electrode 22 in each of the scan electrode groups. This is established also in other fields (rule 2).

Thus, scan electrodes 22 to undergo the forced initializing operation are dispersed in respective fields, so that flicker (image fluctuates) can be reduced comparing with the case where scan electrodes 22 to undergo the forced initializing operation are concentrated to one field.

As shown in FIG. 9, a forced initializing operation is performed in scan electrode SCi in field Fj, and no forced initializing operation is performed in scan electrode SCi-1 and scan electrode SCi+1 that are adjacent to scan electrode SCi in field Fj and next field Fj+1. This is established also in other scan electrodes 22 (rule 3).

Thus, temporal and spatial continuity of scan electrodes 22 to undergo the forced initializing operation reduce, so that the light emission following the forced initializing operation becomes difficult to be recognized by a user. In the second exemplary embodiment, as discussed above, when down-ramp waveform voltage is applied to scan electrodes 22 in the initializing period of subfield SF1, voltage Vx of positive polarity is applied to second data electrodes 39, and voltage 0 (V) equal to the low-voltage-side voltage of the address pulse is applied to first data electrodes 32. When down-ramp waveform voltage is applied to scan electrodes 22 in the initializing periods of subfield SF2 through subfield SF10, voltage Vx of positive polarity is applied to second data electrodes 39, and voltage Vd equal to the high-voltage-side voltage of the address pulse is applied to first data electrodes 32.

Therefore, in the initializing period of at least one subfield SF1, “first voltage V1” is voltage Vx. This is because “first voltage V1” is the voltage derived by subtracting voltage 0 (V) applied to first data electrodes 32 from voltage Vx applied to second data electrodes 39 when the down-ramp waveform voltage is applied to scan electrodes 22 and voltage Vx−voltage 0 (V)=voltage Vx is satisfied.

“Second voltage V2” is voltage 0 (V). This is because “second voltage V2” is the voltage derived by subtracting low-voltage-side voltage 0 (V) of the address pulse applied to first data electrodes 32 from voltage 0 (V) applied to second data electrodes 39 in the address period and voltage 0 (V)−voltage 0 (V)=voltage 0 (V) is satisfied.

Therefore, “first voltage V1” is set at a voltage higher than “second voltage V2” in at least subfield SF1.

Thus, in the address period and sustain period, voltage Vcel′ in the second discharge cell does not arrive at discharge start voltage VFds′ and discharge start voltage VFsd′, so that discharge (accidental discharge) does not occur in the second discharge cell and unnecessary light emission does not occur either.

In the first exemplary embodiment and second exemplary embodiment, as shown in FIG. 3 and FIG. 8, the example of a driving voltage waveform where the number of applications of the down-ramp waveform voltage to scan electrodes 22 is only one for one subfield has been described. However, the present invention is not limited to this driving voltage waveform.

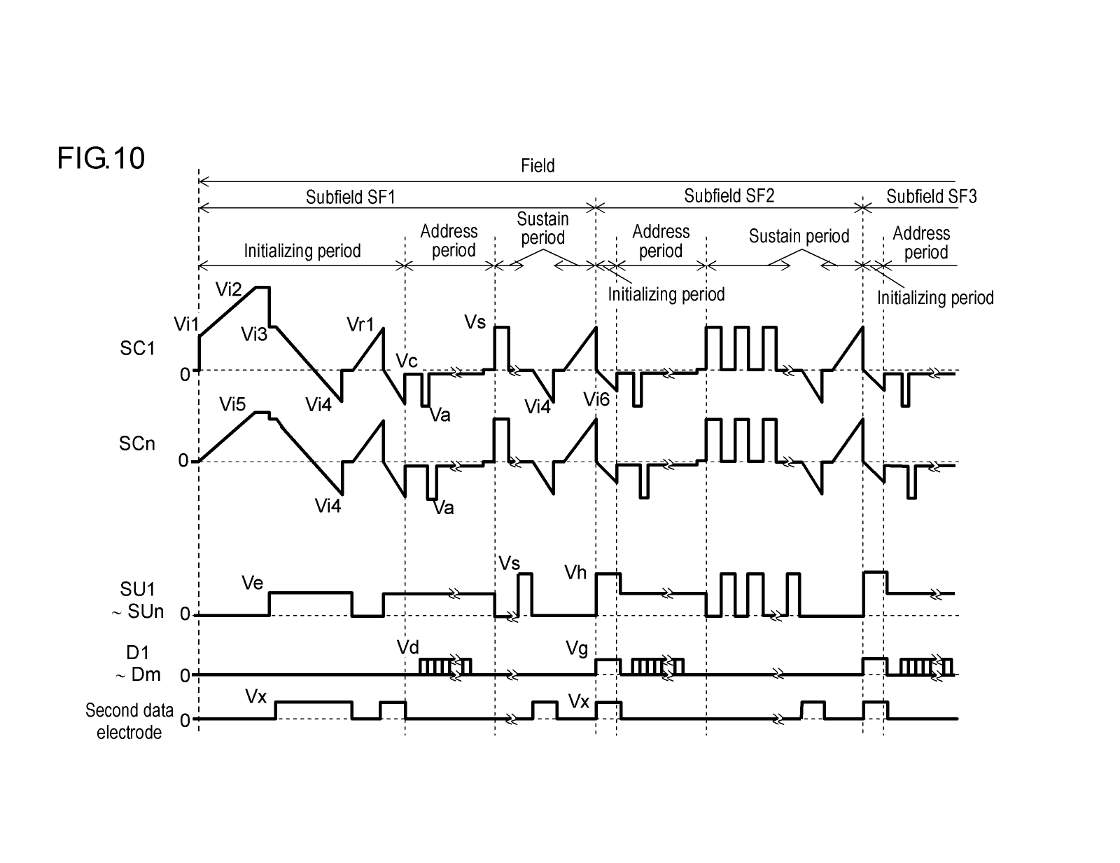

FIG. 10 is a diagram for schematically showing another example of the driving voltage waveform applied to each electrode of panel 10 used for the plasma display apparatus in accordance with the second exemplary embodiment of the present invention. FIG. 10 shows the example of the driving voltage waveform where down-ramp waveform voltage is applied to scan electrodes 22 a plurality of times in one subfield.

FIG. 10 shows driving voltage waveforms applied to scan electrode SC1 for firstly undergoing an address operation in the address period, scan electrode SC2 for secondly undergoing an address operation in the address period, sustain electrode SU1 through sustain electrode SUn, data electrode D1 through data electrode Dm, and second data electrodes 39. FIG. 10 shows driving voltage waveforms of three subfields, namely subfield SF1, subfield SF2, and subfield SF3.

For example, as shown in subfield SF1 of FIG. 10, when the down-ramp waveform voltage is applied to scan electrodes 22 a plurality of times in one subfield, voltage Vx of positive polarity may be applied to second data electrodes 39 and voltage 0 (V) equal to the low-voltage-side voltage of the address pulse may be applied to first data electrodes 32 whenever the down-ramp waveform voltage is applied to scan electrodes 22.

Alternatively, when the down-ramp waveform voltage is applied to scan electrodes 22 a plurality of times in one subfield, voltage Vx of positive polarity may be applied to second data electrodes 39 and voltage 0 (V) equal to the low-voltage-side voltage of the address pulse may be applied to first data electrodes 32 in one of the plurality of applications of the down-ramp waveform voltage to scan electrodes 22. Here, this example of the driving voltage waveform is not shown.

The period in which the down-ramp waveform voltage is applied to scan electrodes 22 corresponds to neither an address operation nor a sustain operation. Therefore, even if such a period is dispersed a plurality of times in one subfield, this period may be substantially considered to be an initializing period.

Panel 10 of FIG. 1 has no phosphor layer 35 on the side surfaces of barrier ribs 34 and on dielectric layer 33 for covering second data electrodes 39. Phosphor layer 35 has a function of disturbing discharge. Therefore, the discharge start voltage is lower in the second discharge cells having no phosphor layer 35 than in the first discharge cells having phosphor layer 35. Discharge (accidental discharge) is more apt to occur in the second discharge cells than in the first discharge cells. In the panel driving method of the present invention, even in such panel 10, a higher effect of preventing accidental discharge from occurring in the second discharge cells can be produced.

The driving voltage waveforms of FIG. 3, FIG. 8, and FIG. 10 are simply one example of the exemplary embodiments of the present invention, and the present invention is not limited to these driving voltage waveforms. The circuit configurations of FIG. 6 and FIG. 7 are also simply one example of the exemplary embodiments of the present invention, and the present invention is not limited to these circuit configurations.

In the exemplary embodiments of the present invention, an example where 10 subfields constitute one field has been described. In the present invention, however, the number of subfields constituting one field is not limited to the above-mentioned value. For example, when the number of subfields is set to be larger than 10, the number of gradations displayable on panel 10 can be further increased. When the number of subfields is set to be smaller than 10, the number of fields generated per second can be further increased.

Each circuit block shown in the exemplary embodiments of the present invention may be configured as an electric circuit for performing each operation shown in the exemplary embodiments, or may be configured using a microcomputer or the like programmed so as to perform a similar operation.

In the exemplary embodiments of the present invention, an example where one pixel is formed of discharge cells of three colors, namely red, green, and blue, has been described. However, also in a panel where one pixel is formed of discharge cells of four or more colors, the configurations shown in the exemplary embodiments of the present invention can be applied and a similar effect can be produced.

Each specific numerical value shown in the exemplary embodiments of the present invention is set based on the characteristics of panel 10 having a screen size of 50 inches and having 1024 display electrode pairs 24, and is simply one example in the embodiments. The present invention is not limited to these numerical values. Numerical values are preferably set optimally in response to the characteristics of the panel or the specification of the plasma display apparatus. These numerical values can vary in a range allowing the above-mentioned effect. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

The present invention can prevent accidental discharge from occurring in second discharge cells and prevent light emission of the second discharge cells from reducing the image display quality, and hence is useful as a panel driving method and a plasma display apparatus.

### REFERENCE MARKS IN THE DRAWINGS

10 panel

21 front substrate

22 scan electrode

23 sustain electrode

24 display electrode pair

25, 33 dielectric layer

26 protective layer

31 rear substrate

32 (first) data electrode

34 barrier rib

35, 35R, 35G, 35B phosphor layer

39 second data electrode

40 plasma display apparatus

41 image signal processing circuit

42 data electrode driver circuit

43 scan electrode driver circuit

44 sustain electrode driver circuit

45 timing generation circuit

49 second data electrode driver circuit

Q95, Q91H1 through Q91Hm, Q91L1 through Q91Lm switching element

D95 diode

R95, R96 resistor

1. A driving method of a plasma display panel that forms one field using a plurality of subfields having an initializing period, an address period and a sustain period,
the plasma display panel comprising:
scan electrodes and sustain electrodes arranged in parallel with each other;
first data electrodes arranged three-dimensionally crossing the scan electrodes; and
second data electrodes arranged in parallel with the first data electrodes in a region outside a region where the plurality of first data electrodes are arranged,
the driving method comprising the steps of
setting a first voltage by subtracting a voltage applied to the first data electrodes from a voltage applied to the second data electrodes when a down-ramp waveform voltage is applied to the scan electrodes in the initializing period,
setting a second voltage by subtracting a low-voltage-side voltage of an address pulse applied to the first data electrodes from a voltage applied to the second data electrodes in the address period; and then
setting the first voltage higher than the second voltage in at least one subfield.

2. The driving method of the plasma display panel of claim 1, wherein
when a down-ramp waveform voltage is applied to the scan electrodes in the initializing period of at least one subfield, a voltage of positive polarity is applied to the second data electrodes and a voltage equal to the low-voltage-side voltage of the address pulse is applied to the first data electrodes, and
when a down-ramp waveform voltage is applied to the scan electrodes in the initializing periods of the other subfields, a voltage of positive polarity is applied to the second data electrodes and a voltage of positive polarity is applied to the first data electrodes.

3. A plasma display apparatus comprising:
a plasma display panel having scan electrodes and sustain electrodes arranged in parallel with each other, first data electrodes arranged three-dimensionally crossing the scan electrodes, and second data electrodes arranged in parallel with the first data electrodes in a region outside a region where the plurality of first data electrodes are arranged; and
a driving circuit for forming one field using a plurality of subfields having an initializing period, an address period, and a sustain period, and generating a driving voltage waveform and applying the driving voltage waveform to each electrode of the plasma display panel,
wherein the driving circuit sets a first voltage higher than a second voltage in at least one subfield, the first voltage is obtained by subtracting a voltage applied to the first data electrodes from a voltage applied to the second data electrodes when a down-ramp waveform voltage is applied to the scan electrodes in the initializing period, the second voltage is obtained by subtracting a low-voltage-side voltage of an address pulse applied to the first data electrodes from a voltage applied to the second data electrodes in the address period.
